(19) United States
(12) Patent Application Publication
(10) Pub. No.: US 2023/0382416 A1
(43) Pub. Date: Nov. 30, 2023

(54) PROMPT METHOD, SYSTEM, DEVICE, AND STORAGE MEDIUM

(71) Applicant: Beijing Tusen Zhitu Technology Co., Ltd., Beijing (CN)

(72) Inventors: Dong LI, Beijing (CN); Siquan CHEN, Beijing (CN); Jie YANG, Beijing (CN)

(21) Appl. No.: 18/319,894

(22) Filed: May 18, 2023

(30) Foreign Application Priority Data
May 24, 2022 (CN) 202210571267.0

(51) Int. Cl. B60W 50/14; B60W 60/00; B60W 10/18

(52) U.S. Cl. CPC B60W 50/14; B60W 10/18; B60W 60/001

(57) ABSTRACT

An autonomous driving method includes receiving a braking instruction from an autonomous driving system; determining a prompt mode based on the braking instruction; and controlling a sound prompt module or a light prompt module to prompt according to the prompt mode. One example includes a prompt scheme, by using a braking instruction from an autonomous driving system and performing a sound and light prompt based on the braking instruction, such that a safety staff can learn the braking intention of a vehicle via the sound or light prompt before the vehicle performs braking.

The present document claims priority to and the benefit of Chinese Patent Application No. 202210571267.0, titled “PROMPT METHOD, SYSTEM, DEVICE, STORAGE MEDIUM AND MOVABLE DEVICE”, filed on May 24, 2022, the content of which is incorporated herein by reference in its entirety.

### TECHNICAL FIELD

The present document relates to the technical field of autonomous driving, in particular to a prompt method, system, device, and storage medium.

### BACKGROUND

In the current autonomous driving system test, the tested vehicle needs to be equipped with safety staff to ensure the safety of the test process; if the human safety staff must take over the autonomous driving system due to failure of the autonomous driving system or for driving safety, it is referred to as “manual take over”, and the number of manual takeover is one of the commonly used indicators to evaluate the technical level of the autonomous driving system. Since the safety staff needs to always pay attention to the surrounding road conditions and various behaviors of the tested vehicle, the braking intention of the autonomous driving system cannot be accurately understood. In some scenarios where the autonomous driving system can avoid the risk by braking, the safety staff may take over manually in advance, which will greatly affect the efficiency of the autonomous driving system test and the effective evaluation of the autonomous driving system.

For this reason, it is beneficial to effectively acquire the braking intention of the autonomous driving system and feed it back to the security staff.

### SUMMARY

Embodiments of the present document provide a solution for prompting a braking intention of an autonomous driving system to address the inability to timely obtain the braking intention of the autonomous driving system during the test.

In order to achieve the above-mentioned objective, the present document adopts the following technical solutions.

According to a first aspect of some embodiments of the present document, provided is a prompt method comprising:

receiving a braking instruction from an autonomous driving system;

determining a prompt mode based on the braking instruction; and

controlling a sound prompt module or a light prompt module to prompt according to the prompt mode.

According to a second aspect of some embodiments of the present document, provided is a prompt system, comprising a controller, a light prompt module and a sound prompt module, the controller being connected to the sound prompt module and the light prompt module, wherein

the controller is configured to receive a braking instruction from an autonomous driving system, determine a prompt mode according to the braking instruction, and control the sound prompt module or the light prompt module to prompt according to the prompt mode;

the sound prompt module is configured to realize a sound prompt corresponding to the prompt mode under the control of the controller; and

the light prompt module is configured to realize a light prompt corresponding to the prompt mode under the control of the controller.

According to a third aspect of some embodiments of the present document, provided is a computing device comprising a processor and a memory, the memory having stored therein at least one machine-executable instruction, the processor executing the at least one machine-executable instruction to perform the aforementioned prompt method.

According to a fourth aspect of some embodiments of the present document, provided is a computer-readable storage medium having stored thereon a computer program which, when executed by a processor, implements the aforementioned prompt method.

According to a fifth aspect of some embodiments of the present document, provided is a movable device on which the aforementioned prompt system is provided.

The present document provides a prompt scheme, by using a braking instruction from an autonomous driving system and performing a sound and light prompt based on the braking instruction, so that a safety staff can learn the braking intention of a vehicle via the sound or light prompt before the vehicle performs braking, improving the timeliness perceived by the safety staff, enabling the safety staff to determine a coping style in advance, and reducing unnecessary attention consumption.

### BRIEF DESCRIPTION OF THE DRAWINGS

In order to explain the embodiments of the present document or the technical solutions in the prior art more clearly, the following will briefly introduce the drawings which need to be used in the embodiments or the description of the prior art; obviously, the drawings in the following description are merely some embodiments of the present document, and it would have been obvious for a person skilled in the art to obtain other drawings according to these drawings without involving any inventive effort.

FIG. 1 is one of the schematic flow diagrams of a prompt method according to some embodiments of the present document.

FIG. 2 is a second schematic flow chart of a prompt method according to some embodiments of the present document;

FIG. 3 is a schematic diagram of a prompt frequency control principle according to some embodiments of the present document;

FIG. 4 is one of the schematic diagrams of a prompt system according to some embodiments of the present document; and

FIG. 5 is a second structural diagram of a prompt system according to some embodiments of the present document.

### DETAILED DESCRIPTION

The embodiments of the present document will now be described more fully hereinafter with reference to the accompanying drawings, in which embodiments of the present document are shown. It is to be understood that the embodiments described are only a few, but not all embodiments of the present document. Based on the embodiments in the present document, all other embodiments obtained by a person skilled in the art without involving any inventive effort are within the scope of protection of the present document.

In this document, the term “a plurality of” means two or more, unless otherwise specified. In this document, the term “and/or” describes an associated relationship of associated objects and encompasses all possible combinations of the listed objects. The character “I” generally indicates that the associated object is an “or” relationship.

In this document, unless otherwise noted, the use of the terms “first”, “second”, and the like are used to distinguish between similar objects and are not intended to limit their positional, temporal, or important relationships. It is to be understood that the terms so used are interchangeable under appropriate circumstances such that the embodiments of the invention described herein are capable of operation in other ways than those illustrated or otherwise described herein.

Furthermore, the terms “comprise” and “have”, as well as any variations thereof, are intended to cover a non-exclusive inclusion, such that a process, method, system, product, or apparatus that comprises a list of steps or elements is not necessarily limited to those steps or elements expressly listed, but may include other steps or elements not expressly listed or inherent to such process, method, system, product, or device.

The term “the movable device” is to be interpreted broadly in the present document to include any moving object, including, for example, an aircraft, a watercraft, a spacecraft, an automobile, a truck, a van, a semitrailer, a motorcycle, a golf cart, an off-road vehicle, a warehouse transportation vehicle, or an agricultural vehicle, as well as a movable device traveling on a track, such as a tram or a train, and other tramcars. A “movable device” in the present document may generally include a power system, a sensor system, a control system, a peripheral device, and a computer system. In other embodiments, the movable device may include more, fewer, or different systems.

The power system is a system for providing powered motion to a movable device, comprising: an engine/motor, a transmission and wheels/tires, and an energy unit.

The control system may comprise a combination of means for controlling the movable device and its components, such as a steering unit, a throttle, and a braking unit.

A peripheral device may be a device that allows a movable device to interact with external sensors, other movable devices, external computing devices, and/or a user, such as a wireless communication system, a touch screen, a microphone, and/or a speaker.

A sensor system and an autonomous driving system are also arranged in a movable device based on the above description, for example, an autonomous vehicle.

The sensor system may include a plurality of sensors for sensing information about the environment in which the movable device is located and one or more actuators for changing the position and/or orientation of the sensors. The sensor system may comprise any combination of sensors such as a global positioning system sensor, an inertial measurement unit, a radio detection and RADAR unit, a camera, a laser range finder, a light detection and LIDAR unit, and/or an acoustic sensor; the sensor system may also include sensors (e.g. 02 monitors, fuel gauges, engine thermometers, etc.) that monitor systems internal to the movable device.

The autonomous driving system may include a processor and a memory, the memory having stored therein at least one machine-executable instruction, the processor executing the at least one machine-executable instruction to perform functions including a map engine, a location module, a sensing module, a navigation or path module, and an automatic control module. The map engine and the location module are used to provide map information and location information. The sensing module is used for sensing things in the environment where the movable device is located according to the information acquired by the sensor system and the map information provided by the map engine. The navigation or path module is used for planning a travel path for the movable device according to the processing results of the map engine, the location module and the perception module. The automatic control module parses and converts the decision information input of the module such as the navigation module or the path module into a control command output for the movable device control system, and sends the control command to a corresponding component in the movable device control system via an on-board network (for example, an internal electronic network system of the movable device realized by means of a CAN bus, a local interconnection network and multimedia directional system transmission) to realize automatic control of the movable device; the automatic control module may also obtain information about components in the movable device via the on-board network.

In implementing the embodiments of the present document, the inventors have found that conventional solutions fail to meet expected testing requirements during road testing of autonomous vehicles, such as some schemes use a variable related to an actual brake deceleration, such as an actual brake deceleration of the vehicle or a brake circuit oil pressure, etc. when determining the brake deceleration of the vehicle, and since the indication is based on the actual brake deceleration, it is not conducive to the safety staff to timely detect the deceleration of the vehicle to avoid the possible risks when the vehicle is already in the process of executing the deceleration at the time of indication; some solutions use a fixed light/sound frequency when the brake prompt is performed, which is not convenient for the safety staff to accurately perceive the intensity of brake deceleration as well as the variation trend.

Based on the above-mentioned problems existing in the prior art, the present document provides a timely and effective vehicle braking intention prompt scheme, wherein by taking a braking instruction of an autonomous driving system as a prompt basis, the current braking intention of the autonomous driving system can be accurately reflected in real time by means of both auditory and/or visual modes to improve the confidence level of a safety staff on the autonomous driving system, thereby optimizing the testing process, improving the efficiency of the testing and also reducing unnecessary attention consumption of the safety staff.

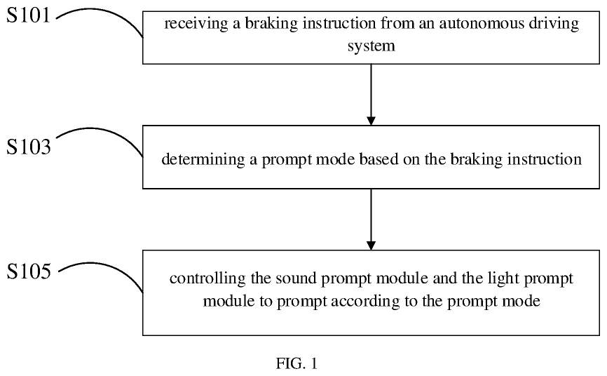

In order to achieve the above-mentioned solution, as shown in FIG. 1, the present document provides a prompt method, comprising the following steps.

At S101, a braking instruction is received from an autonomous driving system.

Specifically, the braking instruction from the autonomous driving system may be received via an on-board network, wherein the on-board network may be a movable device internal electronic network system realized via a CAN bus, a local area interconnection network, multimedia directional system transmission, etc. and is not limited thereto.

At S103, a prompt mode is determined based on the braking instruction.

Specifically, the correspondence relationship between the braking instruction and the prompt mode may be set in advance, so that after receiving the braking instruction, the prompt mode may be determined in conjunction with the correspondence relationship by parsing information in the braking instruction. The prompt mode may comprise: a sound prompt mode, a light prompt mode, or a sound and light prompt mode; and may also comprise a prompt frequency, a prompt volume or a prompt light intensity to realize a targeted prompt under different braking scenes, which prompt modes are specifically used and the corresponding relationship between the prompt mode and the braking instruction can all be set according to actual requirements, and are not limited herein.

At S105, a sound prompt module or a light prompt module is controlled to prompt according to the prompt mode.

Specifically, after determining the corresponding prompt mode according to the braking instruction, the sound prompt module and the light prompt module are controlled according to specific control contents, such as a prompt frequency indicated by the prompt mode to achieve a desired sound and/or light prompt effect.

In the above-mentioned embodiments of the present document, by using the braking instruction of the autonomous driving system as a prompt basis, a deceleration prompt can be realized before the vehicle performs a deceleration action or the security staff perceives that the vehicle decelerates, so that the security staff can learn the braking intention of the autonomous vehicle more timely to a certain extent; at the same time, different prompt modes are set for different braking requirements, so that the sound prompt and/or light prompt can more accurately reflect the braking intention of the autonomous vehicle, and reduce unnecessary manual takeover to improve the test efficiency of the autonomous driving system.

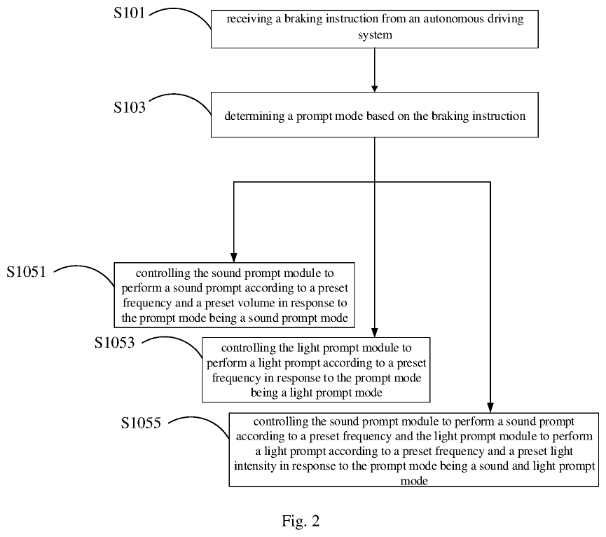

The prompt mode may include: a sound prompt mode, a light prompt mode, or a sound and light prompt mode, respectively representing a sound prompt only, a light prompt only, and a sound and light prompt at the same time, as shown in FIG. 2, the above-mentioned step S105 may further include:

At S1051, the sound prompt module is controlled to perform a sound prompt according to a preset frequency and a preset volume in response to the prompt mode being a sound prompt;

At S1053, the light prompt module is controlled to perform a light prompt according to a preset frequency and a preset light intensity in response to the prompt mode being a light prompt; and

At S1055, the sound prompt module is controlled to perform a sound prompt according to a preset frequency and a preset volume, and the light prompt module is controlled to perform a light prompt according to a preset frequency and a preset light intensity in response to the prompt mode being a sound and light prompt.

In particular, when implementing the present document, a more detailed prompt may be provided according to requirements, for example, when the desired deceleration indicated by the braking instruction reaches the deceleration threshold, a prompt message may be provided by sound and light at the same time, so that the prompt message can reach the safety staff more effectively; when the desired deceleration may be within the deceleration threshold and during the daytime period as indicated by the braking instruction (e.g. at 6: 00 to 19: 00), only the sound prompt shall be used, so that the prompt information reaches the safety staff through sound; when the desired deceleration may be within the deceleration threshold and during nighttime periods as indicated by the braking instruction (e.g. 19: 00 to 24: 00, 24: 00 to 6: 00), only the light prompt shall be used, so that the prompt information reaches the safety staff through the light. Likewise, the above-mentioned preset frequency, preset light intensity, or preset volume may be a fixed value or a set of fixed values related to periods preset according to actual requirements, for example, a relatively large preset volume, preset light intensity, or preset frequency value may be set during the daytime, and a smaller preset volume, preset light intensity or preset frequency value may be set during nighttime; the day and the night period may be further adjusted according to changes in the summer time, winter time, or actual needs, and are not limited herein.

By providing different modes of prompting for different scenarios, the embodiments of the present document can make the prompt information reach the security staff more effectively, so that the security staff can learn the braking intention of the autonomous vehicle more timely, pay attention to the surrounding environment of the vehicle in advance to react in time, thereby improving the efficiency of the autonomous driving test.

Further, since the vehicle test may face various scenes or environments, light conditions, ambient noise levels, current vehicle speeds, and the presence or absence of obstacles, elements such as light conditions, noise levels, and current vehicle speeds may also be added when determining the prompt mode based on the braking instruction when implementing the present scheme, so that the prompt scheme may be more suitable for actual situations. For example, a light level parameter and a noise level parameter can be set, and when the light condition is poor or when the noise is high, a light prompt is preferentially used; when the light condition is better or when the noise is lower, it is preferred to use a sound prompt, so that the prompt message can be touched more effectively.

In some embodiments, the prompt mode indicates a prompt frequency; and a sound prompt module or a light prompt module is controlled to prompt according to the prompt mode, comprising the following A1 or A2.

In A1, the sound prompt module is controlled to perform a sound prompt according to the prompt frequency.

In A2, the light prompt module is controlled to perform a light prompt according to the prompt frequency.

In some embodiments, the prompt mode indicates a prompt volume of the sound prompt module, and the sound prompt module or the light prompt module is controlled to prompt according to the prompt mode, comprising the following B1.

In B1, the sound prompt module is controlled to perform the sound prompt according to the prompt volume.

In some embodiments, the prompt mode indicates a prompt light intensity of the light prompt module, and controlling the sound prompt module or the light prompt module to prompt according to the prompt mode comprises the following C1.

In C1, the light prompt module is controlled to perform the light prompt according to the prompt light intensity.

Further, since a braking instruction generally indicates a desired deceleration, the present document can establish a preset corresponding relationship between the desired deceleration and a prompt frequency, a prompt volume or a prompt light intensity in advance when implemented, so that the prompt frequency, the prompt volume or the prompt light intensity can be determined according to the desired deceleration as per the preset corresponding relationship.

Specifically, when the present document is implemented, a corresponding relationship between a desired deceleration and a prompt frequency, a prompt light intensity and a prompt volume as shown in Table 1 can be established, wherein a1˜a5, Cd_1˜Cd_5, Vol_1˜Vol_5 are all natural numbers, and a1>a2>a3>a4>a5, f_1>f_2>f_3>f_4>f_5, Cd_1>Cd_2>Cd_3>Cd_4>Cd_5, Vol_1>Vol_2>Vol_3>Vol_4>Vol_5, and the specific values can be set according to the load of the system and actual requirements. By establishing the corresponding relationship described in Table 1, a corresponding prompt frequency, prompt light intensity or prompt volume can be acquired after the desired deceleration indicated by the braking instruction is obtained through parsing, so that the sound prompt module can be controlled to perform sound prompt according to the prompt frequency and/or preset volume, or the light prompt module can be controlled to perform light prompt according to the prompt frequency and/or prompt light intensity. By prompting with different frequencies, different light intensities or different prompt volumes for different expected decelerations, the prompt information can more accurately reflect the braking intention of the autonomous vehicle to facilitate the safety staff to timely and accurately understand the current conditions of the autonomous vehicle, and timely feedback can be made for more urgent conditions (such as excessive deceleration), while for general conditions, the loss of attention can be reduced, and unnecessary manual takeover can also be reduced, improving the test efficiency.

TABLE 1

| Desired deceleration (m/s²) | (−a1, −a2] | (−a2, −a3] | (−a3, −a4] | (−a4, −a5] | (−a5, 0] |
|---|---|---|---|---|---|
| Prompt frequency (Hz) | f_1 | f_2 | f_3 | f_4 | f_5 |
| Prompt light intensity (W/cm²) | Cd_1 | Cd_2 | Cd_3 | Cd_4 | Cd_5 |
| Prompt volume (dB) | Vol_1 | Vol 2 | Vol_3 | Vol_4 | Vol_5 |

In the implementation of the present document, different corresponding relationships can be established according to needs, and the above-mentioned methods disclosed in steps S1051-S1055, A1-A2, B1, and C1 can also be used in combination for different situations. For example, when the prompt mode is a sound prompt, and the prompt mode simultaneously indicates a prompt frequency and a prompt volume, the sound prompt module is controlled to perform the sound prompt according to the prompt frequency and the prompt volume; when the prompt mode is a light prompt, and the prompt mode simultaneously indicates a prompt frequency and a prompt light intensity, the light prompt module is controlled to perform the light prompt according to the prompt frequency and the prompt light intensity; when the prompt mode is sound and light prompt and the prompt mode indicates the prompt frequency, prompt volume, and prompt light intensity, the sound prompt module is controlled to perform a sound prompt according to the prompt frequency and prompt volume, and the light prompt module performs a light prompt according to the prompt frequency and prompt light intensity. The above is merely an example of a specific application, and more combinations can be set according to actual requirements, and are not limited herein.

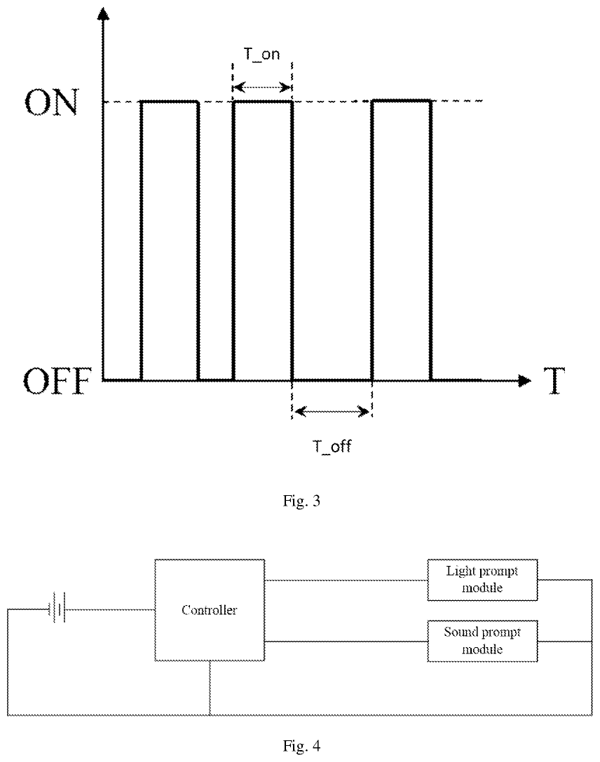

In some embodiments, the present document may change the power supply voltage of the frequency control prompt module or light prompt module by changing the frequency of PWM output of the controller to achieve control of the prompt frequency. As shown in FIG. 3, wherein the vertical axis represents the state of the output voltage, and when the output voltage is ON, the sound prompt module or the light prompt module is activated; when the output voltage is OFF, the sound prompt module and the light prompt module are in the off state. The horizontal axis represents time, T_on represents the time during which the sound prompt module or the light prompt module is activated, T_off represents the time during which the sound prompt module or the light prompt module is turned off, and T_on being 0 represents that the sound prompt module or the light prompt module is always turned off, that is to say, there is no prompt action; T_off of 0 indicates that the sound or light prompt module has been active, i.e. most urgent. Thus, the embodiment can adjust the prompt frequency by changing the values of T_on and T_off (i.e. the pulse width of the output voltage).

In some embodiments, the present document can establish a corresponding relationship between the desired deceleration and T_off as shown in Table 2, wherein b1-b5 and T1-T5 are all natural numbers, and b1>b2>b3>b4>b5, and T1<T2<T3<T4<T5; and the specific values can be set and adjusted according to the system load capacity and actual requirements. It can be seen from Table 2 that the value range of T_off is between [T1, T5], and corresponding to a more urgent condition (the greater the absolute value of the expected deceleration represents the more urgent), the smaller the value of T_off is, i.e., the higher the prompt frequency of the sound prompt module or the light prompt module is; in the case where the braking is gentle, a larger T_off may be set so that the prompt frequency is reduced or not prompted.

TABLE 2

| Desired deceleration (m/s²) | −b1 | −b2 | −b3 | −b4 | −b5 |
|---|---|---|---|---|---|
| T_off time (ms) | T1 | T2 | T3 | T4 | T5 |

Specifically, it the desired deceleration matches the desired deceleration value preset in the table, the T_off time corresponding to the desired deceleration may be directly used in the embodiment; if the expected deceleration does not match the preset expected deceleration value in the table, and does not fall between any two preset expected deceleration values, such as the case where the deceleration is less than-b1 or greater than-b5, the T_off time corresponding to-b1 or-b5 can be used accordingly; if the desired deceleration does not match the preset values in the table, but falls between the two preset desired deceleration values, the corresponding T_off time is calculated by interpolation. For example, when deceleration-bx<—b1 is desired, T_off time Tx=T1 corresponding to-bx may be made; when the desired deceleration-by falls within the (−b4, -b5) interval, the T_off time Ty corresponding to-by may be calculated according to a linear interpolation method, such as Ty=T4+(T5-T4)*(by-b4)/(b5-b4). The above-described embodiment achieves stepless adjustment of the prompt frequency by using interpolation to obtain T_off such that the value of T_off changes continuously with changes in the desired deceleration. The specific manner of interpolation is not limited herein.

With the above-mentioned embodiments, after receiving a braking instruction from an autonomous driving system, the present document may determine a prompt mode according to the braking instruction, and in the case where the prompt mode indicates a prompt frequency, looking up from a table according to a desired deceleration parsed out by the braking instruction or calculating a corresponding T_off time based on a preset value in the table may realize stepless control on the prompt frequency of a sound prompt module or a light prompt module, and realizing corresponding different prompt frequency control for different desired decelerations so that the prompt frequency may more accurately reflect a braking intention of an autonomous vehicle to facilitate the safety staff to identify emergencies of different scenes according to the perceived prompt frequency and adopt corresponding response strategies.

In addition, in order to reduce the attention consumption of the security staff, a constant value T_on is usually set to realize the adjustment of the prompt frequency by changing T_off; however, in the specific implementation, a corresponding relationship similar to that in Table 2 can also be established according to actual requirements to realize a more flexible prompt, which is not limited herein.

Similarly, when the prompt mode indicates the prompt light intensity or prompt volume, PWM can also be used to control the prompt light intensity or prompt volume, and the control of different prompt light intensities or prompt volumes at different expected decelerations can be realized by changing the high-level and low-level duty factor of the output of PWM of the controller; for example, a higher duty factor can be set for a more urgent situation (the greater the absolute value of the desired deceleration represents the more urgent), so that the prompt light intensity is greater or the prompt volume is higher, and the emergency braking information is more effectively transmitted to the safety staff so that they can make better response decisions.

As shown in FIG. 4, the present document also provides a prompt system to achieve the above-mentioned method comprising: a controller, a light prompt module and a sound prompt module, the controller being connected to the sound prompt module and the light prompt module, respectively, wherein

the controller is configured to receive a braking instruction from an autonomous driving system, determine a prompt mode according to the braking instruction, and control the sound prompt module or the light prompt module to prompt according to the prompt mode;

the sound prompt module is configured to realize a sound prompt corresponding to the prompt mode under the control of the controller; and

the light prompt module is configured to realize a light prompt corresponding to the prompt mode under the control of the controller.

Specifically, the above-mentioned controller may be a VCU controller, the above-mentioned sound prompt module may be a prompt buzzer, and the above-mentioned light prompt module may be a monochrome light strip or a multi-color light strip, and the specific implementation method may be adjusted according to the space inside the vehicle and actual requirements, which are not limited herein.

The above-described controller may be used to implement the prompt method as described in the foregoing embodiments, and specific embodiments may be referred to above and will not be described in detail herein.

In some embodiments, the prompt system may further comprise an independent power supply for powering the prompt system, and the controller controls the supply voltage to the sound prompt module and the light prompt module by changing the duty factor and frequency of the PWM output of the controller so as to achieve the control of the light prompt frequency and intensity. By providing an independent power supply, the prompt system is made more stable and reliable, less susceptible to the influence of the lines of the vehicle itself, and the complexity and difficulty of retrofitting can be reduced.

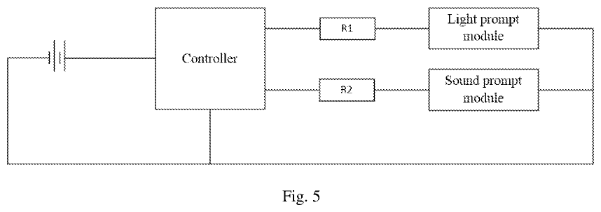

In some embodiments, as shown in FIG. 5, the prompt system may further comprise: a first variable resistor R1 and a second variable resistor R2. A first variable resistor R1 is provided between the controller and the sound prompt module for adjusting the prompt volume of the sound prompt module; a second variable resistor R2 is provided between the controller and the light prompt module for adjusting the prompt light intensity of the light prompt module. In particular, the present document can provide a resistance adjustment switch to facilitate the safety staff to manually adjust the resistance value of the first variable resistor R1 or the second variable resistor R2, for example, during the daytime, by reducing the resistance value of the first variable resistor or the second variable resistor to increase the prompt volume of the sound prompt module or increase the prompt light intensity of the light prompt module.

The present document also provides a computing device comprising a processor and a memory, the memory having stored therein at least one machine-executable instruction, the processor executing the at least one machine-executable instruction to perform the prompt method as and will not be described in detail herein.

The present document also provides a computer-readable storage medium having stored thereon a computer program which, when executed by a processor, implements the prompt method as previously described, and will not be described in detail herein.

The present document also provides a movable device having a prompt system as previously described provided thereon.

The embodiments of the present document can achieve the following technical effects by providing the above-mentioned prompt scheme:

1) by using a braking instruction from the autonomous driving system, and performing sound and light prompts based on the braking instruction, so that the safety staff can learn the braking intention of the vehicle via the sound or light prompt before the vehicle performs braking or before the vehicle performs braking is sensed, improving the timeliness sensed by the safety staff, and enabling the safety staff to determine the coping style in advance;

2) by using the combination of a sound prompt module and a light prompt module, different forms of prompt modes are provided for different scenes and requirements, so that the prompt is more flexible and the prompt information can be more effectively reached to the security staff;

3) by prompting different frequencies, different light intensities or different prompt volumes for different expected decelerations, and steplessly adjusting the prompt frequency, the prompt light intensity or the prompt volume, so that the prompt information can more accurately reflect the braking intention of the autonomous vehicle to facilitate the safety staff to timely and accurately understand the current conditions of the autonomous vehicle, and timely feedback can be made for more urgent conditions, while for general conditions, the loss of attention can be reduced, and unnecessary manual takeover can also be reduced, improving the test efficiency;

4) independent power supply settings also reduce retrofit complexity and difficulty by providing an easy-to-implement system architecture that makes the prompt system easier to apply to autonomous vehicle testing procedures.

It will be understood by a person skilled in the art that embodiments of the present document can be provided as a method, device, or computer program product. Accordingly, the present document may take the form of an entire hardware embodiment, an entire software embodiment, or some embodiments combining software and hardware aspects. Moreover, the present document can take the form of a computer program product embodied on one or more computer-usable storage media (including, but not limited to, magnetic disk storage, CD-ROM, optical storage, etc.) having computer-usable program code embodied therein.

The present document is described with reference to flowchart illustrations and/or block diagrams of methods, devices (systems), and computer program products according to the embodiments of the present document. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general-purpose computer, special-purpose computer, embedded processor, or other programmable data processing device to produce a machine, so that the instructions, which execute via the processor of the computer or other programmable data processing device, create means for implementing the functions specified in the flowchart flow or flows and/or block diagram block or blocks.

These computer program instructions may also be stored in a computer-readable memory that can direct a computer or other programmable data processing device to function in a particular manner, so that the instructions stored in the computer-readable memory produce an article of manufacture including instruction means that implement the function specified in the flowchart flow or flows and/or block diagram block or blocks.

These computer program instructions may also be loaded onto a computer or other programmable data processing device to cause a series of operational steps to be carried out on the computer or other programmable device to produce a computer-implemented process so that the instructions which execute on the computer or other programmable device provide steps for implementing the functions specified in the flowchart flow or flows and/or block diagram block or blocks.

The principles and embodiments of the present document have been set forth in the present document using specific examples. The description of the above examples is intended only to aid in the understanding of the methods of the present document and their core concepts. At the same time, for a person skilled in the art, according to the idea of the present document, there would be changes in the specific embodiments and the present document scope, and in summary, the contents of the present description should not be construed as limiting the present document.

What is claimed is:

1. A prompt method, comprising:
receiving, from an autonomous driving system, a braking instruction;
determining, based on the braking instruction, a prompt mode; and
controlling, according to the prompt mode, a sound prompt module or a light prompt module to prompt.

2. The method according to claim 1, wherein the prompt mode comprises: a sound prompt mode, a light prompt mode, or a sound and light prompt mode; the controlling, according to the prompt mode, the sound prompt module or the light prompt module to prompt comprises:
controlling, in response to the prompt mode being the sound prompt mode, the sound prompt module to perform a sound prompt according to a preset frequency and a preset volume;
controlling, in response to the prompt mode being the light prompt mode, the light prompt module to perform a light prompt according to the preset frequency and a preset light intensity; and
controlling, in response to the prompt mode being the sound and light prompt mode, the sound prompt module to perform the sound prompt according to the preset frequency and the preset volume, and the light prompt module to perform the light prompt according to the preset frequency and the preset light intensity.

3. The method according to claim 1, wherein
in response to the prompt mode indicating a prompt frequency, the controlling, according to the prompt mode, the sound prompt module or the light prompt module to prompt comprises:
controlling, according to the prompt frequency, the sound prompt module to perform a sound prompt; or
controlling, according to the prompt frequency, the light prompt module to perform a light prompt;
in response to the prompt mode indicating a prompt volume of the sound prompt module, the controlling, according to the prompt mode, the sound prompt module or the light prompt module to prompt comprises:
controlling, according to the prompt volume, the sound prompt module to perform a sound prompt;
in response to the prompt mode indicating a prompt light intensity of the light prompt module, the controlling, according to the prompt mode, the sound prompt module or the light prompt module to prompt comprises:
controlling, according to the prompt light intensity, the light prompt module to perform a light prompt.

4. The method according to claim 3, wherein the braking instruction indicates a desired deceleration, and there is a relationship between the desired deceleration and the prompt frequency, the prompt volume, or the prompt light intensity; and the determining, based on the braking instruction, the prompt mode comprises:
determining, based on the relationship, the prompt frequency according to the desired deceleration;
determining, based on the relationship, the prompt volume according to the desired deceleration; or
determining, based on the relationship, the prompt light intensity according to the desired deceleration.

5. The method according to claim 1, wherein the controlling, according to the prompt mode, the sound prompt module or the light prompt module to prompt comprises:
controlling, by changing a frequency of a PWM output, a prompt frequency of the sound prompt module or the light prompt module; or
controlling, by changing a duty factor of the PWM output, a prompt volume of the sound prompt module or a prompt light intensity of the light prompt module.

6. A prompt system, comprising a controller, a light prompt module and a sound prompt module, the controller being connected to the sound prompt module and the light prompt module, respectively, wherein
the controller is configured to receive a braking instruction from an autonomous driving system, determine a prompt mode according to the braking instruction, and control the sound prompt module or the light prompt module to prompt according to the prompt mode;
the sound prompt module is configured to realize a sound prompt corresponding to the prompt mode under the control of the controller; and
the light prompt module is configured to realize a light prompt corresponding to the prompt mode under the control of the controller.

7. The system according to claim 6, wherein the prompt mode comprises: a sound prompt mode, a light prompt mode, or a sound and light prompt mode; the controlling, by the controller, the sound prompt module or the light prompt module to prompt according to the prompt mode comprises:
controlling, by the controller, the sound prompt module to perform a sound prompt according to a preset frequency and a preset volume in response to the prompt mode being the sound prompt mode;
controlling, by the controller, the light prompt module to perform a light prompt according to a preset frequency and a preset light intensity in response to the prompt mode being the light prompt mode; and
controlling, by the controller, the sound prompt module to perform a sound prompt according to a preset frequency and a preset volume, and the light prompt module to perform a light prompt according to a preset frequency and a preset light intensity in response to the prompt mode being the sound and light prompt mode.

8. The system according to claim 6, wherein
in response to the prompt mode indicating a prompt frequency, the controller being configured to control the sound prompt module or the light prompt module to prompt according to the prompt mode comprises:
the controller being configured to control, according to the prompt frequency, the sound prompt module to perform a sound prompt; or
the controller being configured to control, according to the prompt frequency, the light prompt module to perform a light prompt;
in response to the prompt mode indicating a prompt volume of the sound prompt module, the controller being configured to control the sound prompt module or the light prompt module to prompt according to the prompt mode comprises:
the controller being configured to control, according to the prompt volume, the sound prompt module to perform the sound prompt;
in response to the prompt mode indicating a prompt light intensity of the light prompt module, the controller being configured to control the sound prompt module or the light prompt module to prompt according to the prompt mode comprises:
the controller being configured to control, according to the prompt light intensity, the light prompt module to perform the light prompt.

9. The system according to claim 8, wherein the braking instruction indicates a desired deceleration, and there is a relationship between the desired deceleration and the prompt frequency, the prompt volume, or the prompt light intensity; and the controller being configured to determine the prompt mode according to the braking instruction comprises:
the controller being configured to determine, based on the relationship, the prompt frequency according to the desired deceleration;
the controller being configured to determine, based on the relationship, the prompt volume according to the desired deceleration; or
the controller being configured to determine, based on the relationship, the prompt light intensity according to the desired deceleration.

10. The system according to claim 6, wherein the controller being configured to control the sound prompt module or the light prompt module to prompt according to the prompt mode comprises:
the controller being configured to control, by changing a frequency of a PWM output, a prompt frequency of the sound prompt module or the light prompt module; or
the controller being configured to control, by changing a duty factor of the PWM output, a prompt volume of the sound prompt module and a prompt light intensity of the light prompt module.

11. The system according to claim 6, further comprising a first variable resistor being provided between the controller and the sound prompt module and a second variable resistor being provided between the controller and the light prompt module, wherein
the first variable resistor is used for adjusting a prompt volume of the sound prompt module; and
the second variable resistor is used for adjusting a prompt light intensity of the light prompt module.

12. A device, comprising a processor and a memory, the memory having stored therein at least one machine-executable instruction, the processor executing the at least one machine-executable instruction to perform the prompt method according to claim 1.

13. The device according to claim 12, wherein the prompt mode comprises: a sound prompt mode, a light prompt mode, or a sound and light prompt mode; the processor executes the at least one machine-executable instruction to perform the prompt method further comprising:
controlling, in response to the prompt mode being the sound prompt mode, the sound prompt module to perform a sound prompt according to a preset frequency and a preset volume;
controlling, in response to the prompt mode being the light prompt mode, the light prompt module to perform a light prompt according to the preset frequency and a preset light intensity; and
controlling, in response to the prompt mode being the sound and light prompt mode, the sound prompt module to perform the sound prompt according to the preset frequency and the preset volume, and the light prompt module to perform the light prompt according to the preset frequency and the preset light intensity.

14. The device according to claim 12, wherein the processor executes the at least one machine-executable instruction to perform the prompt method further comprising:
in response to the prompt mode indicating a prompt frequency,
controlling, according to the prompt frequency, the sound prompt module to perform a sound prompt; or
controlling, according to the prompt frequency, the light prompt module to perform a light prompt;
in response to the prompt mode indicating a prompt volume of the sound prompt module, controlling, according to the prompt volume, the sound prompt module to perform a sound prompt;
in response to the prompt mode indicating a prompt light intensity of the light prompt module, controlling, according to the prompt light intensity, the light prompt module to perform a light prompt.

15. The device according to claim 12, wherein the processor executes the at least one machine-executable instruction to perform the prompt method further comprising:
controlling, by changing a frequency of a PWM output, a prompt frequency of the sound prompt module or the light prompt module; or
controlling, by changing a duty factor of the PWM output, a prompt volume of the sound prompt module or a prompt light intensity of the light prompt module.

16. A computer-readable storage medium having stored thereon a computer program which when executed by a processor implements a prompt method comprising:
receiving, from an autonomous driving system, a braking instruction;
determining, based on the braking instruction, a prompt mode; and
controlling, according to the prompt mode, a sound prompt module or a light prompt module to prompt.

17. The medium according to claim 16, wherein the prompt mode comprises: a sound prompt mode, a light prompt mode, or a sound and light prompt mode; the computer program when executed by the processor implements the prompt method further comprising:
controlling, in response to the prompt mode being the sound prompt mode, the sound prompt module to perform a sound prompt according to a preset frequency and a preset volume;
controlling, in response to the prompt mode being the light prompt mode, the light prompt module to perform a light prompt according to the preset frequency and a preset light intensity; and
controlling, in response to the prompt mode being the sound and light prompt mode, the sound prompt module to perform the sound prompt according to the preset frequency and the preset volume, and the light prompt module to perform the light prompt according to the preset frequency and the preset light intensity.

18. The medium according to claim 16, wherein the computer program when executed by the processor implements the prompt method further comprising:
in response to the prompt mode indicating a prompt frequency,
controlling, according to the prompt frequency, the sound prompt module to perform a sound prompt; or
controlling, according to the prompt frequency, the light prompt module to perform a light prompt;
in response to the prompt mode indicating a prompt volume of the sound prompt module, controlling, according to the prompt volume, the sound prompt module to perform a sound prompt;
in response to the prompt mode indicating a prompt light intensity of the light prompt module, controlling, according to the prompt light intensity, the light prompt module to perform a light prompt.

19. The medium according to claim 16, wherein the braking instruction indicates a desired deceleration, and there is a relationship between the desired deceleration and a prompt frequency, a prompt volume, or a prompt light intensity; the computer program when executed by the processor implements the prompt method further comprising:
determining, based on the relationship, the prompt frequency according to the desired deceleration;
determining, based on the relationship, the prompt volume according to the desired deceleration; or
determining, based on the relationship, the prompt light intensity according to the desired deceleration.

20. The medium according to claim 16, wherein the computer program when executed by the processor implements the prompt method further comprising:
controlling, by changing a frequency of a PWM output, a prompt frequency of the sound prompt module or the light prompt module; or
controlling, by changing a duty factor of the PWM output, a prompt volume of the sound prompt module or a prompt light intensity of the light prompt module.
